(19) United States
(12) Patent Application Publication
(10) Pub. No.: US 2026/0032108 A1
(43) Pub. Date: Jan. 29, 2026

(54) TELEMETRY DRIVEN ENCRYPTION FOR QUANTUM-RESISTANT SECURITY

(71) Applicant: BANK OF AMERICA CORPORATION, Charlotte, NC (US)

(72) Inventor: Vijay Kumar Yarabolu, Hyderabad (IN)

(73) Assignee: BANK OF AMERICA CORPORATION, Charlotte, NC (US)

(21) Appl. No.: 18/783,923

(22) Filed: Jul. 25, 2024

(51) Int. Cl. H04L 9/40

(52) U.S. Cl. CPC H04L 63/0435

(57) ABSTRACT

Encrypting data based on its metadata and the telemetric data of the upstream and downstream servers. Establish a secure connection between an upstream server and a downstream server and encrypt the data being transmitted by retrieving first telemetric data of the upstream server and second telemetric data of the downstream server at a specific time. Subsequently, aggregate the first and second telemetric data and retrieve metadata for the data being transmitted. Generate an encryption key based on the aggregated telemetric data and the metadata and use the encryption key to encrypt the data. Subsequently, the encrypted data is received and decrypted by the downstream server.

### TECHNOLOGICAL FIELD

The present invention is related generally to the secure transmission of data, and more specifically, using telemetric data to generate encryption keys to encrypt data being transmitted.

### BACKGROUND

Encryption processes are used to ensure the security of data. Traditional encryption methods, such has asymmetric encryption or the use of hash keys, use complex mathematical solutions to encrypt data. However, mathematical solutions like those can be solved or reversed with quantum computing, as quantum computers have significantly faster and more advanced computational capabilities than the traditional computers that encrypt the data. Furthermore, while traditional encryption methods aim to ensure the security of data being transmitted, they do not ensure the accuracy of such data.

Therefore, a need exists to develop systems, computerized methods, computer program products and the like that will allow for stronger encryption of data that cannot be easily reversed with higher computational capabilities. As such, a need exists to develop systems, methods and the like for data encryption that is quantum-resistant. Through applied effort, ingenuity, and innovation, many of these identified problems have been solved by developing solutions that are included in embodiments of the present disclosure, many examples of which are described in detail herein.

### BRIEF SUMMARY

The following presents a simplified summary of one or more embodiments of the invention in order to provide a basic understanding of such embodiments. This summary is not an extensive overview of all contemplated embodiments and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention provide for systems, methods, computer program products and the like that provide for data encryption that can withstand the computational powers of a quantum computer. Specifically, the present invention provides for the secure transmission of data by first establishing a secure connection between the upstream server and the downstream server, where the upstream server is the server encrypting and transmitting the data and the downstream server is the server receiving and decrypting the data. In some embodiments of the invention, the central authorizer establishes a secure connection with the use of public and private encryption keys of the upstream and downstream servers.

The upstream server encrypts the data by first retrieving the telemetric data of the upstream server and the downstream server at a specific time. In some embodiments of the invention, the specific time for which the telemetric data of the servers is retrieved is the time at which the data transmission is initiated by the upstream server. The upstream server then aggregates the telemetric data of the upstream server and the telemetric data of the downstream server and also retrieves the metadata of the data being transmitted. It then uses both the aggregated telemetric data and the metadata to create an encryption key that is then applied to the data to encrypt it. In some embodiments of the invention, the upstream server may also generate a heat map of the aggregated telemetric data and use the heat map in addition to or in lieu of the aggregated telemetric data (along with the metadata) to create the encryption key.

The downstream server receives the data from the upstream server and decrypts it by retrieving the time at which the telemetric data was captured, retrieving the telemetric data of both the upstream server and the downstream server at that time, retrieving the metadata of the data being transmitted and creating a decryption key using both the sets of telemetric data and the metadata. In some embodiments of the invention, the downstream server also retrieves a unique identifier of the upstream server and uses the identifier to create the decryption key in addition to the telemetric data and the metadata. The downstream server then applies the decryption key to the data to decrypt it.

As such, the present invention provides for the secure transmission of data. By using a combination of telemetric data specific to the upstream/sending and downstream/receiving servers, the encryption of the data is specific to the specific transmission between the upstream and downstream servers and not simply a mathematical solution that can be reversed with higher or more sophisticated computational powers.

A system for the encryption of data being transmitted defines first embodiments of the invention. The system comprises a central authorizer, an upstream server, and a downstream server. The upstream server, or the sending server, is the server that encrypts the data and transmits the data to the downstream server. The downstream server, or the receiving server, is the server that receives the encrypted data from the upstream server and decrypts the data.

The central authorizer is configured to establish a secure connection between the upstream server and the downstream server. In some embodiments, the central authorizer establishes a secure connection between the upstream server and the downstream server by using public and private encryption keys and ensuring the public and private encryption keys are compatible, as will be described in more detail below.

The upstream server is configured to encrypt the data being transmitted to transmit the data to the downstream server. In specific embodiments of the invention, the upstream server only encrypts the data after a secure connection is established between the upstream server and the downstream server. To encrypt the data, the upstream server captures the telemetric data of the upstream server and the telemetric data of the downstream server. The telemetric data of a server is constantly changing. As such, any telemetric data captured is the telemetric data for the particular moment in time. The upstream server therefore collects the telemetric data of the upstream server at a specific time and collects the telemetric data of the downstream server at that same specific time. In some embodiments of the invention, the specific time for which the telemetric data of both the upstream and downstream servers are collected is the time that the data transmission is initiated by the upstream server.

Encrypting the data further comprises combining the telemetric data of the upstream server and the telemetric data of the downstream server to generate aggregated telemetric data. The upstream server also retrieves the metadata of the data being transmitted, which contains information about the characteristics of the data. The upstream server then uses the aggregated telemetric data in combination with the metadata to create an encryption key that is specific to this particular data and this particular transmission. In some embodiments of the invention, the upstream server if further configured to generate a heat map based on the aggregated telemetric data and use the heat map in addition to or in lieu of the aggregated telemetric data when creating the encryption key. The upstream server can then apply the encryption key to the data to encrypt it.

The downstream server is configured to receive the encrypted data and decrypt it. In some embodiments of the invention, the downstream server decrypts the data by retrieving telemetric data of the upstream server and the downstream server for the same specific time at which the upstream server captured the telemetric data during the encryption process. The downstream server further retrieves the metadata of the data being transmitted and generates a decryption key using the telemetric data of the upstream server, the telemetric data of the downstream server and the metadata. In further embodiments of the invention, the downstream server also retrieves a unique identifier of the upstream server and uses the unique identifier in addition to the telemetric data and the metadata to generate the decryption key. The downstream server then applies the decryption key to the encrypted data to decrypt the data.

A method for encrypting data being transmitted defines second embodiments of the invention. The method comprises establishing a secure connection between an upstream server and a downstream server, encrypting the data, and transmitting the data to the downstream server. Establishing a secure connection comprises using public and private encryption keys and ensuring the public and private encryption keys are compatible. In some embodiments of the invention, encrypting the data occurs in response to a secure connection between the upstream server and the downstream server being established. Encrypting the data comprises retrieving the telemetric data of the upstream server and the telemetric data of the downstream server. The telemetric data of the upstream server that is retrieved is the telemetric data of the upstream server at a specific time and the telemetric data of the downstream server is the telemetric data of the downstream server at that same specific time. In some embodiments of the invention, the specific time for which the telemetric data is retrieved is the time at which the transmission of the data is initiated.

Encrypting the data further comprises generating aggregated telemetric data by combining the telemetric data of the upstream server and the telemetric data of the downstream server and retrieving the metadata of the data being transmitted. Encrypting the data further comprises generating an encryption key for the data being transmitted using the aggregated telemetric data in combination with the metadata. In some embodiments of the invention, encrypting the data further comprises generating a heat map of the aggregated telemetric data and using the heat map to generate the encryption key. Encrypting the data finally comprises applying the encryption key to data to encrypt it.

The method further comprises receiving and decrypting the data. Decrypting the data comprises retrieving the telemetric data of the upstream server and the telemetric data of the downstream server for the same time the upstream server captured the telemetric data during the encryption process. Decrypting the data further comprises retrieving the metadata of the data being transmitted and generating a decryption key using the telemetric data of the upstream server, the telemetric data of the downstream server and the metadata. In some embodiments of the invention, the method may further comprise retrieving a unique identifier of the upstream server and using the unique identifier to generate decryption key. Decrypting the data finally comprises applying the decryption key to the encrypted data to decrypt the data.

A computer program product for encrypting data being transmitted and including at least one non-transitory computer-readable medium defines third embodiments of the invention. The computer-readable medium includes computer-readable program code portions that comprise executable portions. One executable portion is configured to establish a secure connection between the upstream server and the downstream server. In some embodiments of the invention, the secure connection is established by using public and private encryption keys and ensuring that the public and private encryption keys are compatible. Another executable portion is configured to encrypt the data being transmitted and to transmit the encrypted data to the downstream server. In some embodiments of the invention, the data is encrypted in response to the secure connection being established between the upstream server and the downstream server. Encrypting the data comprises retrieving the telemetric data of the upstream server and the telemetric data of the downstream server. The telemetric data of the upstream server that is retrieved is the telemetric data of the upstream server at a specific time and the telemetric data of the downstream server is the telemetric data of the downstream server at that same specific time. In some embodiments of the invention, the specific time for which the telemetric data is retrieved is the time at which the transmission of the data is initiated.

Encrypting the data further comprises generating aggregated telemetric data by combining the telemetric data of the upstream server and the telemetric data of the downstream server and retrieving the metadata of the data being transmitted. Encrypting the data further comprises generating an encryption key for the data being transmitted using the aggregated telemetric data in combination with the metadata. In some embodiments of the invention, encrypting the data further comprises generating a heat map of the aggregated telemetric data and using the heat map to generate the encryption key. Encrypting the data finally comprises applying the encryption key to data to encrypt it.

Another executable portion is configured to receive the data and to decrypt the data. Decrypting the data comprises retrieving the telemetric data of the upstream server and the telemetric data of the downstream server for the same time the upstream server captured the telemetric data during the encryption process. Decrypting the data further comprises retrieving the metadata of the data being transmitted and generating a decryption key using the telemetric data of the upstream server, the telemetric data of the downstream server and the metadata. In some embodiments of the invention, the decrypting the data may further comprise retrieving a unique identifier of the upstream server and using the unique identifier to generate decryption key. Decrypting the data finally comprises applying the decryption key to the encrypted data to decrypt the data.

Thus, according to embodiments of the invention, which will be discussed in greater detail below, the present invention provides for the secure transmission of data using encryption based on time-specific telemetric data and the metadata of the data being transmitted. Specifically, the present invention provides for a secure connection between the upstream/sending server and the downstream/receiving server and the generation of an encryption key using an aggregate of the time-specific telemetric data of both the upstream and downstream servers in combination with the metadata of the data being transmitted. In some embodiments, the secure connection is established using public and private encryption keys and the data is encrypted in response to the connection being established. In further embodiments, the time for which the telemetric data is captured is the time at which the data transmission is initiated. In some embodiments, the invention further provides for the decryption of the data by generating a decryption key using the telemetric data of the upstream and downstream servers and the metadata of the data being transmitted. In further embodiments, the encryption key may be generated by also using a heat map created based on the aggregated telemetric data and the decryption key may be generated by also using a unique identifier of the upstream server.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. The features, functions, and advantages that have been discussed may be achieved independently in various embodiments of the present invention or may be combined with yet other embodiments. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for the encryption of data being transmitted in accordance with an embodiment of the disclosure.

FIG. 2 illustrates a process flow for the encryption of data being transmitted, in accordance with an embodiment of the disclosure.

FIG. 3 illustrates a process flow for the generation of an encryption key, in accordance with an embodiment of the disclosure.

FIG. 4 illustrates a process flow for establishing a secure connection between the upstream server and the downstream server, in accordance with an embodiment of the disclosure.

FIG. 5 illustrates a process flow for the decryption of the data transmitted, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a quantum computer is any computer that utilizes the principles of quantum physics to perform computational operations. Several variations of quantum computer design are known, including photonic quantum computing, superconducting quantum computing, nuclear magnetic resonance quantum computing, and/or ion-trap quantum computing. Regardless of the particular type of quantum computer implementation, all quantum computers encode data onto qubits. Whereas classical computers encode bits into ones and zeros, quantum computers encode data by placing a qubit into one of two identifiable quantum states. Unlike conventional bits, however, qubits exhibit quantum behavior, allowing the quantum computer to process a vast number of calculations simultaneously.

A qubit can be formed by any two-state quantum mechanical system. For example, in some embodiments, a qubit may be the polarization of a single photon or the spin of an electron. Qubits are subject to quantum phenomena that cause them to behave much differently than classical bits. Quantum phenomena include superposition, entanglement, tunneling, superconductivity, and the like.

Two quantum phenomena are especially important to the behavior of qubits in a quantum computer: superposition and entanglement. Superposition refers to the ability of a quantum particle to be in multiple states at the same time. Entanglement refers to the correlation between two quantum particles that forces the particles to behave in the same way even if they are separated by great distances. Together, these two principles allow a quantum computer to process a vast number of calculations simultaneously.

In a quantum computer with n qubits, the quantum computer can be in a superposition of up to 2ⁿ states simultaneously. By comparison, a classical computer can only be in one of the 2ⁿ states at a single time. As such, a quantum computer can perform vastly more calculations in a given time period than its classical counterpart. For example, a quantum computer with two qubits can store the information of four classical bits. This is because the two qubits will be a superposition of all four possible combinations of two classical bits (00, 01, 10, or 11). Similarly, a three-qubit system can store the information of eight classical bits, four qubits can store the information of sixteen classical bits, and so on. A quantum computer with three hundred qubits could possess the processing power equivalent to the number of atoms in the known universe.

Despite the seemingly limitless possibilities of quantum computers, present quantum computers are not yet substitutes for general purpose computers. Instead, quantum computers can outperform classical computers in a specialized set of computational problems. Principally, quantum computers have demonstrated superiority in solving optimization problems. Generally speaking, the term “optimization problem” as used throughout this application describe a problem of finding the best solution from a set of all feasible solutions. In accordance with some embodiments of the present invention, quantum computers as described herein are designed to perform adiabatic quantum computation and/or quantum annealing. Quantum computers designed to perform adiabatic quantum computation and/or quantum annealing are able to solve optimization problems as contemplated herein in real time or near real time.

Embodiments of the present disclosure provide for the secure transmission of data using encryption methods that can withstand the processing and computational power of quantum computers.

As described above, quantum computers have the ability to make significantly faster computations as compared to classical computers. Current encryption methods use encryption keys and algorithms that are essentially the result of complex mathematical solutions. Because quantum computers have such high processing and computational power, they can easily solve and reverse such mathematical solutions, and break the encryption keys. Therefore, current encryption methods are vulnerable to quantum computers.

As stated above, present quantum computers are not yet substitutes for general purpose computers, but instead simply excel at computational problems. A method of encryption that uses the telemetric state of the servers between which the data is being transmitted to generate an encryption key would be able to resist quantum computers because the exact temporal telemetric data would be required to generate a corresponding decryption key. Furthermore, by generating the encryption key using both temporal telemetric data and the metadata of the data being transferred, the server receiving the data would be able to use the metadata to ensure that the data received is accurate and matches the data that was intended to be sent. Such a method of encryption would, therefore, ensure the accurate and secure transmission of data that quantum computing would not be able to pierce.

Accordingly, the present disclosure includes a central authorizer that is configured to establish a secure connection between an upstream/sending server and a downstream/receiving server. In some embodiments of the invention, the central authorizer uses public and private encryption keys of the upstream and downstream servers to establish the secure connection, by ensuring the public and private keys are compatible. The present disclosure further includes the upstream server that is configured to encrypt the data being transmitted and to transmit the data upon encryption. In some embodiments, the upstream server encrypts the data in response to the central authorizer establishing a secure connection between the upstream and downstream servers.

Encrypting the data includes retrieving telemetric data of the upstream server for a specific time and retrieving telemetric data of the downstream server for that same specific time. In some embodiments, the specific time for which the telemetric data of the servers is retrieved is the time that the upstream server initiates the transmission of the data. Encrypting the data further comprises combining the telemetric data of the upstream and downstream servers to create aggregated telemetric data, retrieving the metadata of the data being transmitted and generating an encryption key using both the telemetric data and the metadata. In some embodiments of the invention, encrypting the data further comprises generating a heat map based on the aggregated telemetric data and using the heat map in addition to or in lieu of the aggregated telemetric data when generating the encryption key. Encrypting the data further includes applying the encryption key to the data to encrypt it.

The present disclosure further includes a downstream server that is configured to receive the encrypted data from the upstream server and decrypt it. Decrypting the data includes retrieving the telemetric data of the upstream and downstream servers for the same specific time that the upstream server captured the telemetric data during the encryption process and retrieving the metadata of the data being transmitted. Decrypting the data further includes generating a decryption key using the telemetric data of the upstream and downstream servers and the metadata and applying the decryption key to the encrypted data to decrypt it. In some embodiments of the invention, decrypting the data may further include retrieving a unique identifier of the upstream server and using the unique identifier, in addition to the telemetric data of the upstream and downstream servers and the metadata, to generate the decryption key.

What is more, the present disclosure provides a technical solution to a technical problem. As described herein, the technical problem includes traditional encryption methods being vulnerable to attacks from quantum computers. The technical solution presented herein allows for a novel encryption method that includes generating an encryption key using time-specific telemetric data of the sending and receiving servers and the metadata of the data being transmitted. In particular, this method of generating an encryption key based on time-specific telemetric data of the servers and the metadata of the data being transmitted is an improvement over existing solutions to the problem of encryption vulnerabilities in the time of quantum computing, (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

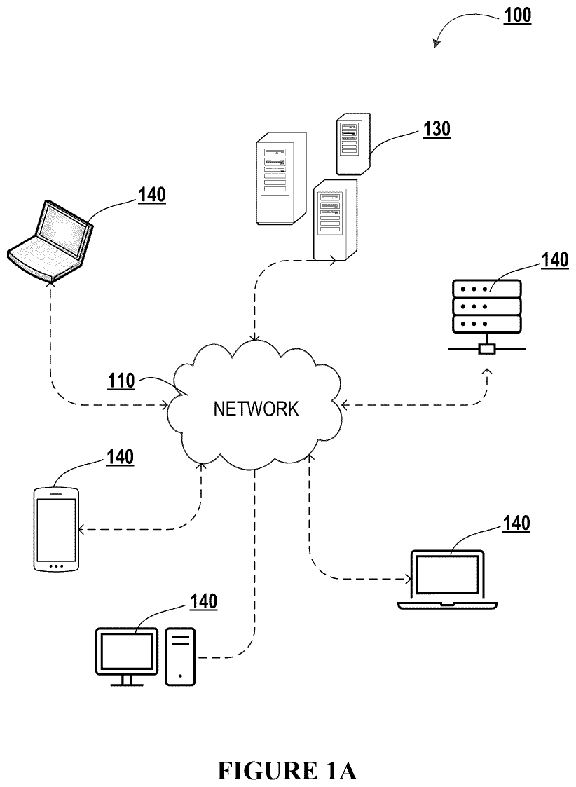

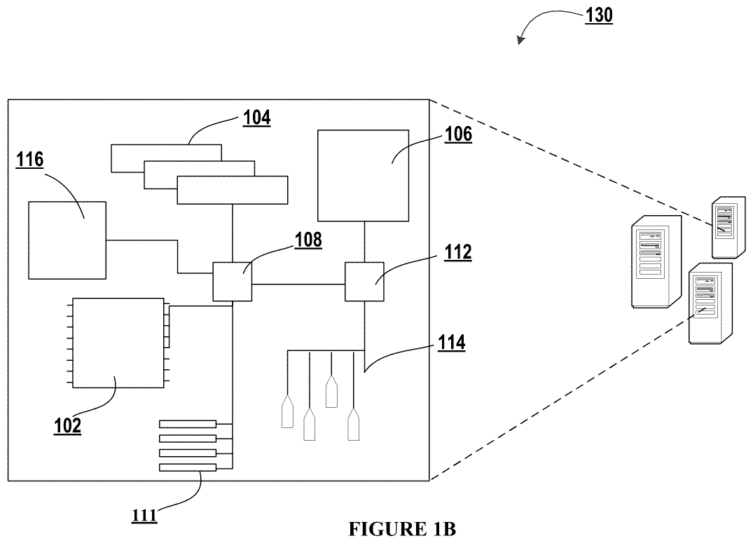

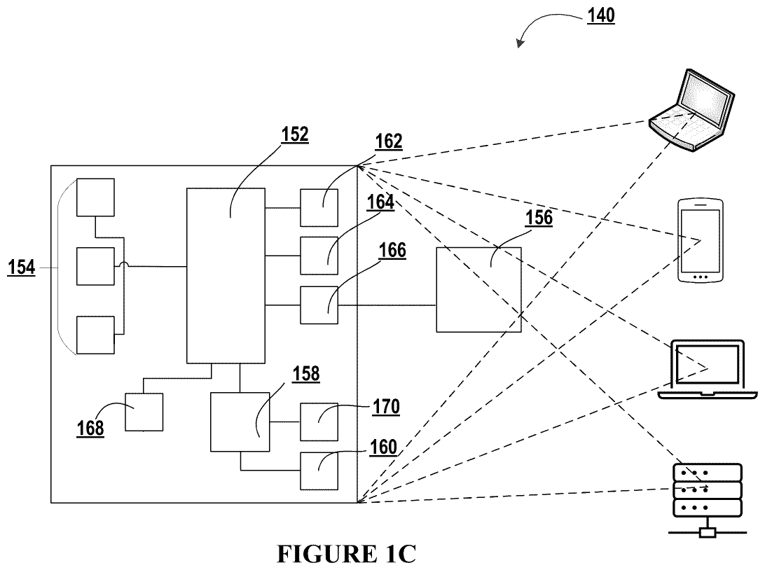

FIGS. 1A-1C illustrate technical components of an exemplary distributed computing environment for encrypting data being transmitted 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low-speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low-speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing, and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation—and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

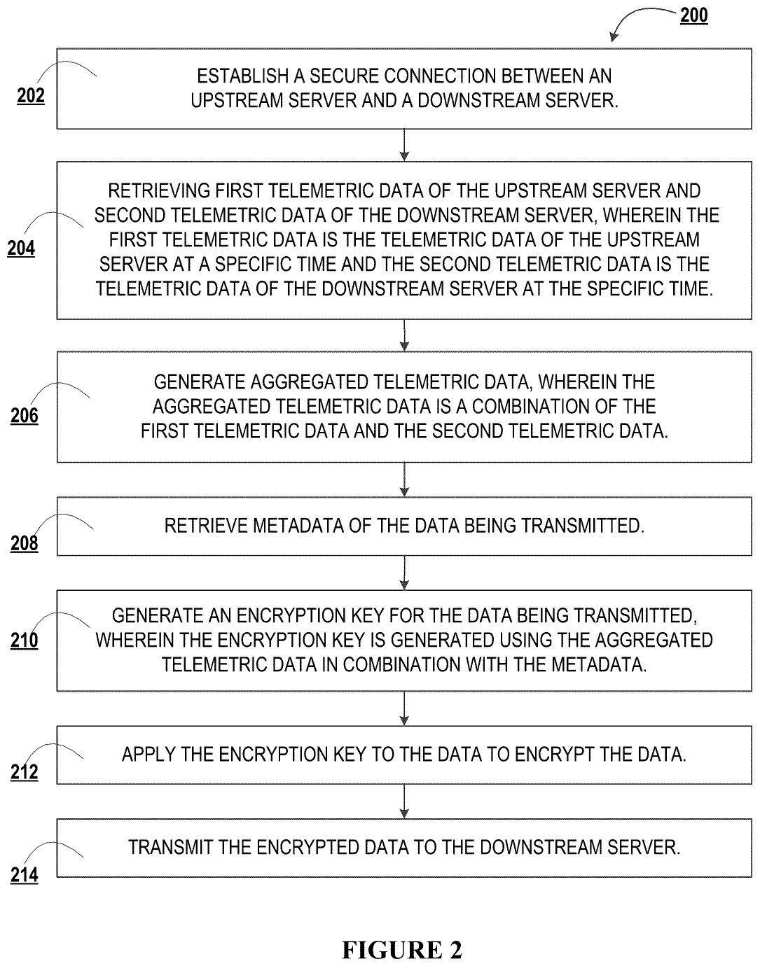

FIG. 2 depicts a flow diagram of method 200 for encrypting data being transmitted. At Event 202, a secure connection is established between an upstream server and a downstream server, where the upstream server is the server encrypting and sending the data and the downstream server is the server receiving and decrypting the data. In some embodiments, the secure connection may be established by using public and private encryption keys for the upstream and downstream servers and ensuring the public and private keys are compatible.

At Event 204, telemetric data of the upstream server and telemetric data of the downstream server are retrieved. The telemetric data of the upstream server and the downstream server must be retrieved for the same time. Telemetric data of servers is changing constantly and in certain embodiments of this invention, the retrieved telemetric data is a snapshot of the telemetry of the server at a certain point in time. Thus, the snapshot of the upstream server and the snapshot of the downstream server must be a snapshot for the same specific time. For example, if the telemetric data retrieved for the upstream server is the telemetric data of the upstream server at exactly 10:02 am on Jul. 4, 2023, the telemetric data retrieved for the downstream server must also be the telemetric data of the downstream server at exactly 10:02 am on Jul. 4, 2023. In some embodiments of the invention, the specific time for which the telemetric data of the servers is captured is the time at which the transmission of data is initiated.

At Event 206, aggregated telemetric data is generated, where the aggregated telemetric data is a combination of the telemetric data of the upstream server and the telemetric data of the downstream server that were retrieved at Event 204. In some embodiments, a heat map based on the aggregated telemetric data is also generated.

At Event 208, the metadata of the data being transferred is retrieved.

At Event 210, an encryption key is generated using the aggregated telemetric data in combination with the metadata. In some embodiments, the encryption key is generated using the aggregated telemetric data, the heat map, and the metadata. In other embodiments, the encryption key is generated using the heat map and the metadata.

At Event 212, the encryption key is applied to the data to encrypt it and at Event 214, the encrypted data is transmitted to the downstream server.

In some embodiments of the invention the data is received by the downstream server and decrypted after it is transmitted in Event 214. The data is decrypted by first retrieving the telemetric data of the upstream server and the telemetric data of the downstream server for the same time the upstream server retrieved the telemetric data in Event 204. Then the metadata of the data being transmitted is retrieved and a decryption key is generated using the telemetric data of the upstream and downstream servers and the metadata. In some embodiments of the invention, a unique identifier of the upstream server is also retrieved and used to generate the decryption key. The decryption key is then applied to the encrypted data to decrypt it.

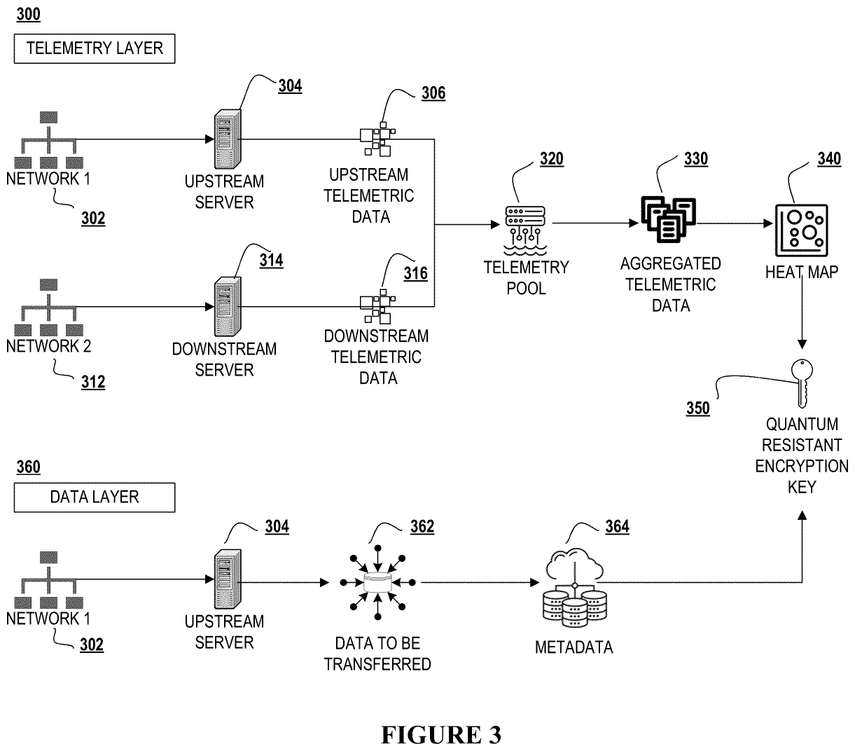

FIG. 3 depicts the process of generating the encryption key. In specific embodiments of the invention, there may be two layers of data collection: the telemetry layer 300 and the data layer 360. The telemetry layer 300 consists of the upstream server 304 and the downstream server 314 that are part of network 1 302 and network 2 312 respectively. The telemetric data of the upstream server at a specific time, i.e., the upstream telemetric data 306, and the telemetric data of the downstream server at that same specific time, i.e., the downstream telemetric data 316, are collected into a telemetry pool 320. Telemetric data includes various telemetry attributes and corresponding metric values. Such attributes may include, among others, CPU utilization, memory usage, incoming network traffic, outgoing network traffic, disk space, fan speed, power consumption, and the like. Such telemetric data can provide a snapshot of the state of the server at any particular moment. This data in telemetry pool 320 comprising both the upstream and downstream telemetric data is combined to create aggregated telemetric data 330. In some embodiments of the invention, the telemetric data of the upstream server 306 and the telemetric data of the downstream server 316 is aggregated in a specific way. In some embodiments of the invention, a heat map 340 is generated based on the aggregated telemetric data 330.

The data layer 360 includes the upstream server 304 that is part of network 1 302. The upstream server 304 has the data to be transferred 362 to the downstream server. This is the data that needs to be encrypted by the upstream server 304 and securely transmitted to the downstream server 314. The metadata 364 of the data to be transferred 362 is collected. Metadata may comprise various characteristics of the data to be transferred 363. Such characteristics may include types of files, file size, overall size of the data, and the like.

The metadata 364 and the aggregated telemetric data 330 are then used to generate a quantum resistant encryption key 350. In some embodiments, the heat map 340 and the metadata 364 are used to generate the quantum resistant encryption key 350.

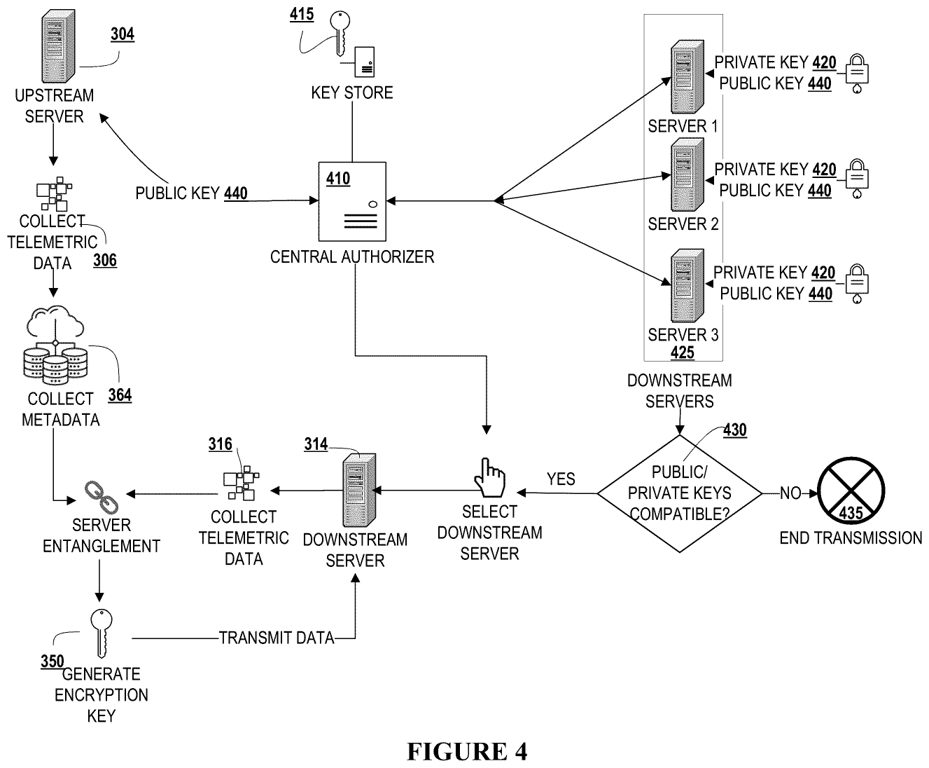

FIG. 4 depicts the process of the central authorizer 410 establishing a secure connection between the upstream server 304 and the downstream server 314 and the generation of encryption key 350. The central authorizer 410 uses public and private encryption keys, 440 and 420 respectively to establish a secure connection. In some embodiments of the invention, the downstream server 314 generates a private key 420 and a public key 440. The downstream server 314 retains the private key 420 and sends the public key 440 to the upstream server 304. The upstream server 304 stores the public key 440. The downstream server 314 can then connect to the upstream server 304 using the corresponding private key 420. In specific embodiments of the invention, the central authorizer 410 can manage this interaction. The central authorizer 410 can store the public keys 440 and private keys 420 in a key store 415. In further embodiments of the invention, using this public and private encryption key process, the central authorizer 310 can select the downstream server that the data needs to be transmitted to out of multiple possible downstream servers. The central authorizer 410 can make this selection by ensuring the downstream server's private key is the private key corresponding with the upstream server's public key, i.e., by ensuring the public and private keys are compatible 430. If there is no downstream server with a corresponding private key 420, the transmission is terminated 435.

Once the downstream server 314 is selected, the encryption process depicted in FIG. 3 begins, with the collection of the telemetric data of the upstream and downstream servers, 306 and 316 respectively, the collection of the metadata 364 and the generation of the quantum resistant encryption key 350.

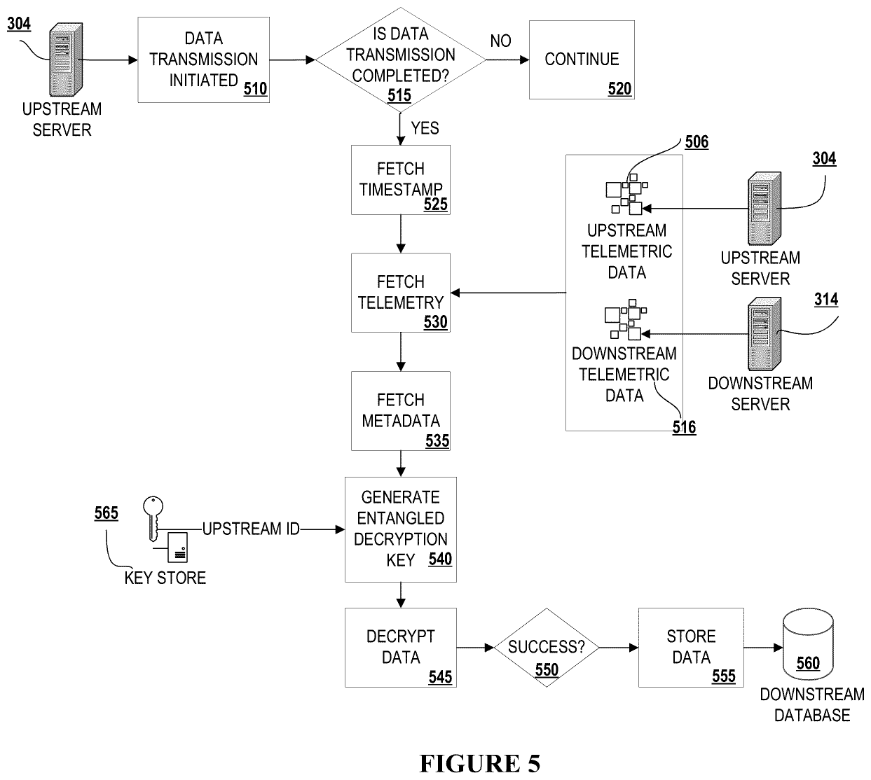

FIG. 5 depicts the decryption process. The data transmission is initiated 510 by the upstream server 304. If the data transmission is completed 515, the decryption process begins. Otherwise, the data transmission continues 520. The decryption process includes first retrieving the timestamp 525. The timestamp is the specific time at which the upstream server 304 captured the telemetric data of the upstream and downstream servers, 306 and 316 respectively, during the encryption process, as depicted in FIG. 3. Then, the decryption process includes retrieving the telemetric data of the upstream server 506 and the telemetric data of the downstream server 516 at the timestamp (i.e., fetching telemetry 530). The telemetric data of the upstream and downstream servers may be retrieved using telemetry logs, where each server may have a telemetry log that stores the telemetric data of the server over a period of time. The decryption process also includes retrieving the metadata of the data being transmitted (i.e., fetching metadata 535). Then a decryption key is generated 540 based on the telemetric data and metadata retrieved. In some embodiments, the decryption key may also be generated using a unique identifier of the upstream server. The unique identifier may be retrieved from the key store 565. The decryption key may be applied to the data to decrypt the data 545. In some embodiments of the invention, the success of the data transmission may be checked 550. Success of data transmission can mean, among other things, the accuracy of the data transmitted. This can be checked by comparing the metadata of the data before encryption or transmission to the metadata of the data after transmission or decryption. Once the success of the transmission is confirmed, the data may be stored 555 in the downstream database 560.

Thus, present embodiments of the invention discussed in detail above, the present invention provides for the secure transmission of data using encryption based on time-specific telemetric data and the metadata of the data being transmitted. Specifically, the present invention provides for a secure connection between the upstream/sending server and the downstream/receiving server and the generation of an encryption key using an aggregate of the time-specific telemetric data of both the upstream and downstream servers in combination with the metadata of the data being transmitted. In some embodiments, the secure connection is established using public and private encryption keys and the data is encrypted in response to the connection being established. In further embodiments, the time for which the telemetric data is captured is the time at which the data transmission is initiated. In some embodiments, the invention further provides for the decryption of the data by generating a decryption key using the telemetric data of the upstream and downstream servers and the metadata of the data being transmitted. In further embodiments, the encryption key may be generated by also using a heat map created based on the aggregated telemetric data and the decryption key may be generated by also using a unique identifier of the upstream server.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for encrypting data being transmitted, the system comprising:
a central authorizer, wherein the central authorizer is configured to establish a secure connection between an upstream server and a downstream server; and
the upstream server, configured to encrypt the data being transmitted and transmit the encrypted data to the downstream server, wherein encrypting the data comprises:
retrieving first telemetric data of the upstream server and second telemetric data of the downstream server, wherein the first telemetric data is the telemetric data of the upstream server at a specific time and the second telemetric data is the telemetric data of the downstream server at the specific time;
generating aggregated telemetric data, wherein the aggregated telemetric data is a combination of the first telemetric data and the second telemetric data;
retrieving metadata of the data being transmitted;
generating an encryption key for the data being transmitted, wherein the encryption key is generated using the aggregated telemetric data in combination with the metadata; and
applying the encryption key to the data to encrypt the data; and
the downstream server, configured to receive the data and decrypt the data.

2. The system of claim 1, wherein the specific time associated with the first and second telemetric data being retrieved is the time at which the transmission of the data is initiated by the upstream server.

3. The system of claim 1, wherein the downstream server is further configured to decrypt the data by:
retrieving the first telemetric data of the upstream server and the second telemetric data of the downstream server;
retrieving the metadata of the data being transmitted;
generating a decryption key using the first telemetric data, the second telemetric data and the metadata of the data being transmitted; and
applying the decryption key to the encrypted data to decrypt the data.

4. The system of claim 3, wherein the downstream server is further configured to decrypt the data by:
retrieving a unique identifier of the upstream server; and
generating the decryption key using the unique identifier of the upstream server.

5. The system of claim 1, wherein the central authorizer is further configured to establish the secure connection by:
collecting and storing public and private encryption keys; and
ensuring the public and private keys are compatible.

6. The system of claim 1, wherein the upstream server is further configured to encrypt the data being transmitted in response to the central authorizer establishing a secure connection between the upstream server and the downstream server.

7. The system of claim 1, wherein the upstream server is further configured to generate a heat map based on the aggregated telemetric data and wherein encrypting the data further comprises generating the encryption key using the heat map.

8. A method for encrypting data being transmitted, the method comprising:
establishing a secure connection between an upstream server and a downstream server; and
encrypting the data, wherein encrypting the data comprises:
retrieving first telemetric data of the upstream server and second telemetric data of the downstream server, wherein the first telemetric data is the telemetric data of the upstream server at a specific time and the second telemetric data is the telemetric data of the downstream server at the specific time;
generating aggregated telemetric data, wherein the aggregated telemetric data is a combination of the first telemetric data and the second telemetric data;
retrieving metadata of the data being transmitted;
generating an encryption key for the data being transmitted, wherein the encryption key is generated using the aggregated telemetric data in combination with the metadata; and
applying the encryption key to the data to encrypt the data; and
transmitting the encrypted data to the downstream server.

9. The method of claim 8, wherein the specific time associated with the first and second telemetric data being retrieved is the time at which the transmission of the data is initiated by the upstream server.

10. The method of claim 8, wherein the method further comprises receiving and decrypting the data, wherein decrypting the data comprises:
retrieving the first telemetric data of the upstream server and the second telemetric data of the downstream server;
retrieving the metadata of the data being transmitted;
generating a decryption key using the first telemetric data, the second telemetric data and the metadata of the data being transmitted; and
applying the decryption key to the data to decrypt the data.

11. The method of claim 10, wherein decrypting the data further comprises:
retrieving a unique identifier of the upstream server; and
generating the decryption key using the unique identifier of the upstream server.

12. The method of claim 8, wherein establishing a secure connection comprises:
collecting and storing public and private encryption; and
ensuring the public and private keys are compatible.

13. The method of claim 8, wherein the data being transmitted is encrypted in response to a secure connection between the upstream server and the downstream server being established.

14. The method of claim 8, wherein method further comprises generating a heat map based on the aggregated telemetric data and wherein encrypting the data further comprises generating the encryption key using the heat map.

15. A computer program product for encrypting data being transmitted, the computer program product comprising at least one non-transitory computer-readable medium having computer-readable program code portions embodied therein, the computer readable code portions comprising:
an executable portion configured to establish a secure connection between an upstream server and a downstream server; and
an executable portion configured to encrypt the data being transmitted and transmit the encrypted data to the downstream server, wherein encrypting the data comprises:
retrieving first telemetric data of the upstream server and second telemetric data of the downstream server, wherein the first telemetric data is the telemetric data of the upstream server at a specific time and the second telemetric data is the telemetric data of the downstream server at the specific time;
generating aggregated telemetric data, wherein the aggregated telemetric data is a combination of the first telemetric data and the second telemetric data;
retrieving metadata of the data being transmitted;
generating an encryption key for the data being transmitted, wherein the encryption key is generated using the aggregated telemetric data in combination with the metadata; and
applying the encryption key to the data to encrypt the data; and
an executable portion configured to receive the data and decrypt the data.

16. The computer program product of claim 15, wherein the specific time associated with the first and second telemetric data being retrieved is the time at which the transmission of the data is initiated by the upstream server.

17. The computer program product of claim 15, wherein the computer readable code portions further comprise an executable portion configured to decrypt the data by:
retrieving the first telemetric data of the upstream server and the second telemetric data of the downstream server;
retrieving the metadata of the data being transmitted;
generating a decryption key using the first telemetric data, the second telemetric data and the metadata of the data being transmitted; and
applying the decryption key to the encrypted data to decrypt the data.

18. The computer program product of claim 17, wherein the computer readable code portions further comprise an executable portion configured to decrypt the data by:
retrieving a unique identifier of the upstream server; and
generating the decryption key using the unique identifier of the upstream server.

19. The computer program product of claim 15, wherein the computer readable code portions further comprise an executable portion configured to establish the secure connection by:
collecting and storing public and private encryption keys; and
ensuring the public and private keys are compatible.

20. The computer program product of claim 15, wherein the computer readable code portions further comprise an executable portion configured to encrypt the data being transmitted in response to a secure connection being established between the upstream server and the downstream server.
